(19) United States
(12) Patent Application Publication
(10) Pub. No.: US 2019/0280786 A1
(43) Pub. Date: Sep. 12, 2019

(54) METHOD FOR TRANSMITTING MEASUREMENT SIGNAL AND APPARATUS

(71) Applicant: HUAWEI TECHNOLOGIES CO., LTD., SHENZHEN (CN)

(72) Inventors: Jun Luo, Kista (SE); Jin Liu, Shenzhen (CN); Pu Yuan, Shanghai (CN)

(21) Appl. No.: 16/420,863

(22) Filed: May 23, 2019

Related U.S. Application Data
(63) Continuation of application No. PCT/CN2017/100293, filed on Sep. 2, 2017.

(30) Foreign Application Priority Data
Jan. 3, 2017 (CN) 201710002460.1

(51) Int. Cl. H04B 17/309; H04W 24/08

(52) U.S. Cl. CPC H04B 17/309; H04W 24/08

(57) ABSTRACT

The present disclosure provides a method and an apparatus for transmitting a measurement signal. A method for sending a measurement signal includes: sending, by a network device, downlink measurement signals to a terminal device by using one or more transmit beams; receiving, by the network device, a detection result, fed back by the terminal device, of signal strength of the downlink measurement signals of the one or more transmit beams; and when detecting that the detection result, fed back by the terminal device, of the downlink measurement signals is lower than a specified threshold, instructing, by the network device, the terminal device to use an uplink measurement signal-based measurement manner. According to the method, switching between measurement manners is performed based on a detection result, thereby reducing signaling overheads.

### CROSS-REFERENCE TO RELATED APPLICATIONS

This application is a continuation of International Application No. PCT/CN2017/100293, filed on Sep. 2, 2017, which claims priority to Chinese Patent Application No. 201710002460.1, filed on Jan. 3, 2017, both of which are hereby incorporated by reference in their entireties.

### TECHNICAL FIELD

The present disclosure relates to the field of wireless communications, and more specifically, to a method for transmitting a measurement signal and an apparatus.

### BACKGROUND

Radio resource management in an existing wireless communications system usually uses a downlink measurement signal-based measurement manner. To be specific, a base station sends a downlink measurement signal such as a reference signal RS (Reference Signal), and a terminal device measures a parameter such as RSRP (Reference Signal Received Power)/RSRQ (Reference Signal Received Quality) of the reference signal sent by the base station, and reports a detection result to the base station. The base station determines handover and movement of the terminal device based on the detection result.

To reduce dependence of radio resource management on fixed and frequent sending of a downlink measurement signal by a network, and to improve system efficiency, introduction of an uplink measurement signal-based measurement method is considered. To be specific, a terminal device sends an uplink measurement signal; and a network device, such as a base station or a TRP (transmission reception point), associated with the terminal device and a neighboring base station or TRP measure the uplink signal sent by the terminal device, and compare detection results of the base stations or the TRPs, so as to determine to hand over the terminal device to a proper cell for service.

To satisfy large-capacity and high-rate transmission requirements of a mobile communications system, a high-frequency band higher than 6 GHz is introduced for communication, to utilize high-bandwidth and high-rate transmission features of the high-frequency band. However, due to a high path loss of high-frequency communications, a narrow beam needs to be used to ensure a propagation distance and a high beam gain. Therefore, a directional narrow beam is also used for transmission of the uplink measurement signal or the downlink measurement signal. A relatively large quantity of measurement overheads are generated due to a relatively large quantity of beams in the high-frequency communications.

### SUMMARY

The present disclosure provides a method for transmitting a measurement signal and an apparatus to reduce system overheads.

With reference to the foregoing aspects, an uplink measurement signal is an uplink reference signal or an uplink tracking signal.

With reference to the foregoing aspects, a downlink measurement signal is a downlink reference signal, a channel state information-reference signal, or a measurement reference signal.

With reference to the foregoing aspects, a measurement parameter of the uplink measurement signal or the downlink measurement signal is RSRP or RSRQ, or another measurement parameter such as a CQI (Channel Quality Indicator), an RI (Rank Indicator), or a PMI (Precoding Matrix indicator).

With reference to the foregoing aspects, a network device is a base station or a TRP, or another type of network device.

According to a method of a first aspect, a network device is further provided, including:

a receiving module, configured to receive uplink measurement signals that are sent by a terminal device by a plurality of transmit beams;

a detection module, configured to determine a beam direction of an optimal transmit beam based on signal strength information of the uplink measurement signals of the plurality of beams; and

a sending module, configured to send a downlink measurement signal to the terminal device by using a corresponding downlink transmit beam based on the beam direction of the optimal transmit beam.

According to a method of a second aspect, a terminal device is provided, including:

a receiving module, configured to receive downlink measurement signals that are sent by a network device by a plurality of transmit beams;

a detection module, configured to determine a beam direction of an optimal transmit beam based on signal strength information of the downlink measurement signals of the plurality of transmit beams; and

a sending module, configured to send an uplink measurement signal to the network device by using a corresponding uplink transmit beam based on the beam direction of the optimal transmit beam.

With reference to the foregoing aspects, the optimal transmit beam is a transmit beam with highest signal strength or a transmit beam whose signal strength is higher than a specified threshold.

According to a method of a third aspect, a network device is further provided, including a sending module, a receiving module, and a detection module, where

the sending module is configured to send downlink measurement signals to a terminal device by using one or more transmit beams;

the receiving module is configured to receive a detection result, fed back by the terminal device, of signal strength of the downlink measurement signals of the one or more transmit beams; and

when the detection module detects that the detection result, fed back by the terminal device, of the downlink measurement signals is lower than a specified threshold, the sending module is further configured to instruct the terminal device to use an uplink measurement signal-based measurement manner.

With reference to the foregoing aspects, the receiving module is further configured to receive uplink measurement signals that are sent by the terminal device by using one or more beams.

According to a method of a fourth aspect, a terminal device is provided, including:

a receiving module, configured to receive downlink measurement signals that are sent by a network device by using one or more beams; and

a detection module, configured to: detect signal strength of the downlink measurement signals and feed back a detection result to the network device, where

when the network device detects that the detection result, fed back by the terminal device, of the downlink measurement signals is lower than a specified threshold, the receiving module is further configured to receive a notification that is sent by the network device and that indicates to use an uplink measurement signal-based measurement manner.

With reference to the foregoing aspects, the terminal device further includes a sending module, configured to send uplink measurement signals to the network device by using one or more beams.

The foregoing apparatuses respectively correspond to corresponding network devices or terminal devices in the methods, and use corresponding modules to separately perform corresponding operations in the methods. Details are not described herein.

In an apparatus embodiment of another form, the receiving module may be implemented by a receiver; the sending module may be implemented by a transmitter; and the detection module and the detection module may be implemented by a processor. Functions corresponding to operations, except transmitting/receiving, in another method procedure may be implemented by a processor.

In the solutions of the foregoing aspects of the present disclosure, a corresponding measurement signal is sent based on a determined optimal transmit beam, thereby reducing measurement overheads. In addition, switching between measurement manners is performed based on a detection result, thereby reducing signaling overheads.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may derive other drawings from these accompanying drawings without creative efforts.

FIG. 1 is a flowchart of a method for sending a measurement signal according to an embodiment of the present disclosure;

FIG. 2 is a flowchart of a method for sending a measurement signal according to another embodiment of the present disclosure;

FIG. 3 is a flowchart of a method for sending a measurement signal according to still another embodiment of the present disclosure;

FIG. 4 is a schematic diagram of a reference signal burst according to an embodiment of the present disclosure;

FIG. 5 is a schematic diagram of an apparatus for sending a measurement signal according to an embodiment of the present disclosure;

FIG. 6 is a schematic diagram of an apparatus for sending a measurement signal according to another embodiment of the present disclosure; and

FIG. 7 is a schematic diagram of an apparatus for sending a measurement signal according to still another embodiment of the present disclosure.

### DESCRIPTION OF EMBODIMENTS

Embodiments of the present disclosure may be used in wireless networks using various technologies. In different systems, a radio access network device may include different network elements. For example, in LTE (Long Term Evolution), LTE-A (LTE Advanced), and 5G NR (New Radio), network elements of a radio access network include an eNB (eNodeB, evolved NodeB), a TRP (transmission reception point), and the like. Network elements of a WLAN (wireless local area network)/Wi-Fi include an access point (AP) and the like. In another wireless network, a solution similar to the embodiments of the present disclosure may also be used. However, related modules in a base station system may be different from those in the present disclosure. This is not limited in the embodiments of the present disclosure.

It should be further understood that in the embodiments of the present disclosure, a terminal device includes but is not limited to user equipment (UE), a mobile station (MS), a mobile terminal, a mobile phone, a handset, portable equipment, and the like. The user equipment may communicate with one or more core networks by using a radio access network (RAN). For example, the user equipment may be a mobile phone (or referred to as a “cellular” telephone), or a computer having a wireless communication function; alternatively, the user equipment may be a portable, pocket-sized, handheld, computer built-in, or in-vehicle mobile apparatus.

During high-frequency communications, a narrow beam needs to be used to ensure a propagation distance and a high beam gain, and beam alignment is performed to ensure communication quality. Therefore, during communication between a network device and different terminal devices, the communication is implemented on different beam pairs. The network device sends a measurement signal by using a transmit beam (TX beam), and the terminal device receives the measurement signal by using a corresponding receive beam (RX beam). Similarly, the terminal device sends a measurement signal by using a transmit beam (TX beam), and the network device receives the measurement signal by using a corresponding receive beam (RX beam).

In a next-generation wireless communications system, namely, a 5G communications system, which is also referred to as an NR (New Radio) system, to reduce dependence of radio resource management on fixed and frequent sending of a downlink reference signal by a network, and to improve system efficiency, introduction of an uplink measurement signal-based measurement method is considered. To be specific, a terminal device sends an uplink measurement signal; and a base station or a transmission reception point (TRP) associated with the terminal device and a neighboring base station or TRP measure the uplink signal sent by the terminal device, and compare detection results of the base stations or the TRPs, so as to determine to hand over the terminal device to a proper cell for service. In a 5G system, a base station may include one or more TRPs, and a cell may be a coverage area formed by one or more TRPs. The uplink signal is used for measurement, so that the network can track the terminal device, and the network can not only track a current location of the terminal device, but also know which TRP or base station can currently provide optimal transmission.

To improve network efficiency, and provide better flexibility for radio resource management, an embodiment of the present disclosure provides an uplink-downlink measurement signal hybrid sending manner in a scenario of a high-frequency communications system, to improve measurement accuracy and reduce measurement signal overheads.

Embodiment 1 provides a method for sending a downlink measurement signal in a high-frequency system, where the sending is assisted by a network device and a terminal device by using an uplink signal. The terminal device sends uplink measurement signals on a plurality of uplink transmit beams, where the uplink measurement signal may be, for example, an uplink SRS (sounding reference signal), an uplink tracking signal, or another measurement signal. The network device determines a beam direction of an optimal transmit beam based on signal strength of the received uplink measurement signals, and sends a downlink measurement signal by using a corresponding downlink beam based on the beam direction.

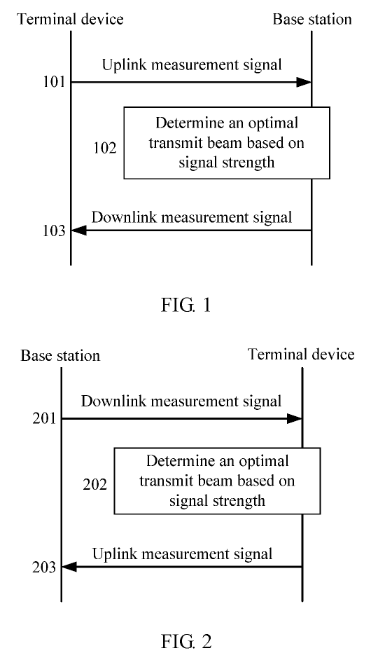

The following is described by using an example in which the network device is a base station. Referring to FIG. 1, the method for sending a downlink measurement signal includes the following operations.

Operation 101. The terminal device separately sends uplink measurement signals by a plurality of transmit beams.

The terminal device may separately send the uplink measurement signals on different uplink transmit beams in a manner of beam sweeping. The uplink measurement signal may be, for example, an SRS, a tracking signal, or another measurement signal. The base station may receive uplink measurement signals of one or more beams, which are usually uplink measurement signals of a plurality of beams.

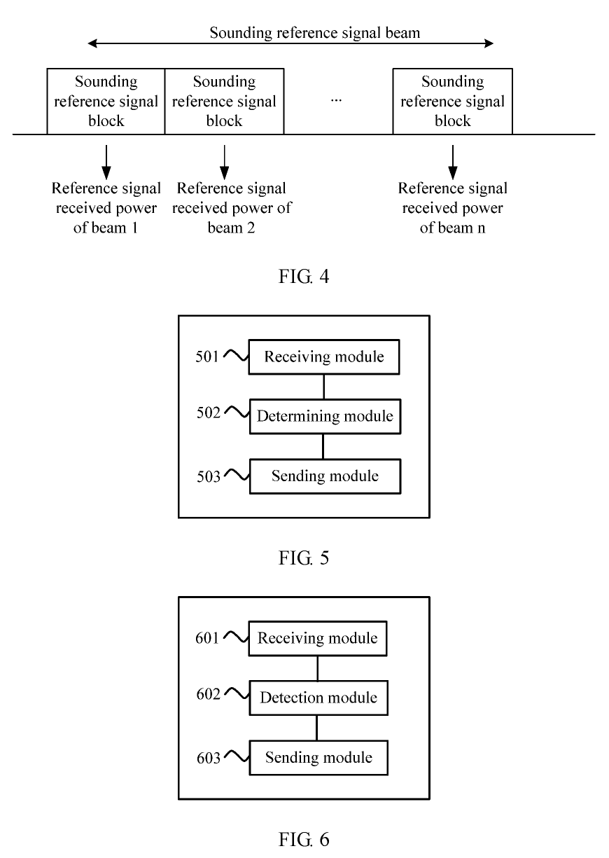

Referring to FIG. 4, the terminal device may send uplink measurement signals for a plurality of uplink transmit beams (TX beam) in one UL SRS burst, where one UL SRS burst includes a plurality of UL SRS blocks. Each UL SRS block is used to send an uplink measurement signal on one transmit beam, and each UL SRS block occupies one or more symbols. All transmit beams of the terminal device or some of the transmit beams may be polled in one UL SRS burst.

Operation 102. The base station receives the uplink measurement signals that are sent by the plurality of transmit beams, detects signal strength of the uplink measurement signals of the beams, and determines a beam direction of an optimal transmit beam.

For example, the base station receives SRS of a plurality of SRS blocks and detects signal strength information of each SRS. The signal strength information may be based on an RSRP/RSRQ value or based on a CQI value, or may use a detection value of another type, such as an RI or a PMI. Because each SRS block corresponds to one transmit beam, a TRP may determine a beam direction of a transmit beam with highest signal strength based on signal strength information of an SRS corresponding to each received SRS block. The transmit beam with the highest signal strength is the optimal transmit beam.

In addition, alternatively, a threshold may be set, and a beam whose signal strength is higher than the threshold is used as the optimal transmit beam. In this case, there may be one or more optimal transmit beams.

Because the base station uses a corresponding receive beam to receive an uplink measurement signal that is sent by the terminal device, an optimal transmit beam of the terminal corresponds to an optimal receive beam of the base station.

Operation 103. The base station sends a downlink measurement signal to the terminal device by using a corresponding downlink beam based on the beam direction of the optimal transmit beam.

For the terminal device, the base station sends the downlink measurement signal by using the corresponding downlink transmit beam based on the beam direction of the optimal transmit beam. The downlink measurement signal may be a CSI-RS (channel state information-reference signal) or an SS (Synchronization Signal) for the terminal device; or a reference signal RS or an MRS (measurement reference signal) for the beams; or a reference signal of another type. This is not limited in this embodiment of the present disclosure.

Subsequently, the terminal device may detect the reference signal sent by the base station and report a detection result to the base station, so that the base station may perform corresponding processing based on the detection result of the terminal device. This procedure is available in the prior art. Details are not described herein.

Embodiment 2 provides a method for sending an uplink measurement signal in a high-frequency system, where the sending is assisted by a network device and a terminal device by using a downlink signal. A base station sends downlink measurement signals on a plurality of downlink transmit beams, where the downlink measurement signal may be a downlink MRS or another measurement signal. The terminal device determines a beam direction of an optimal transmit beam based on signal strength of the received downlink measurement signals, and sends an uplink measurement signal by using a corresponding uplink transmit beam based on the beam direction.

Referring to FIG. 2, the method for sending an uplink measurement signal includes the following operations.

Operation 201. The base station sends downlink measurement signals by a plurality of transmit beams.

The base station may send the downlink measurement signals on the plurality of downlink transmit beams in a manner of beam sweeping. If there are a plurality of base stations, the downlink measurement signals may be sent separately in the manner of beam sweeping. The downlink measurement signal may be a measurement reference signal MRS, or a measurement signal of another type mentioned in the foregoing embodiment.

Operation 202. The terminal device receives the downlink measurement signals, detects signal strength information of the downlink measurement signals, and determines a beam direction of an optimal transmit beam.

For example, the terminal device detects signal strength of the downlink measurement signals and determines a transmit beam with highest signal strength as the optimal transmit beam, for example, the terminal device may measure RSRP or RSRQ of each beam to determine the optimal transmit beam. Further, the terminal device may feed back an optimal downlink transmit beam to the base station.

In addition, alternatively, a threshold may be set, and a beam whose signal strength is higher than the threshold is used as the optimal transmit beam. In this case, there may be one or more optimal transmit beams.

Operation 203. The terminal device sends an uplink measurement signal to the base station by using a corresponding uplink transmit beam based on the beam direction of the optimal transmit beam.

The terminal device sends, in the direction of the optimal transmit beam, the uplink measurement signal to the base station by using the corresponding uplink beam. The uplink measurement signal may be an uplink tracking signal or an uplink reference signal. The uplink measurement signal may be sent in a manner of beam sweeping.

Subsequently, the base station may measure the uplink measurement signal sent by the terminal device and perform corresponding processing based on a detection result. This procedure is available in the prior art. Details are not described herein.

In addition to the foregoing method for determining an optimal transmit beam, in another implementation, a manner of determining an optimal port may also be used. After receiving the downlink measurement signals sent by the base station, the terminal device may also measure each port corresponding to the downlink measurement signal. Based on an obtained measurement indicator (which may be, for example RSRP or RSRQ) of the port, the terminal device determines the optimal port, for example, a port with highest signal strength, and then sends an uplink measurement signal by using a corresponding transmit beam based on one or more beam directions corresponding to the optimal port. The port is a time-frequency resource location of a corresponding measurement signal. One port may correspond to one or more transmit beams. The base station may notify the terminal device in advance of a number of a port that needs to be measured.

In addition, alternatively, a threshold may be set, and a port whose measurement indicator is higher than the threshold is used as the optimal port. The base station may notify the terminal device in advance of the threshold.

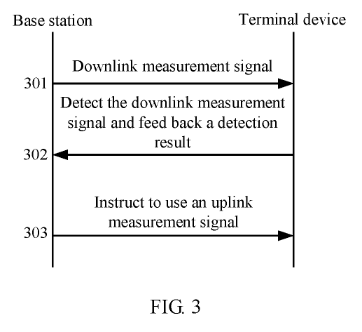

Embodiment 3 provides a method for sending a wireless measurement signal by a terminal device and a base station in an uplink-downlink hybrid manner in a high-frequency system. Referring to FIG. 3, the method includes the following operations.

Operation 301. The base station sends downlink measurement signals to the terminal device by a plurality of transmit beams.

The base station may send the downlink measurement signals on downlink beams in different directions in a manner of beam sweeping, so that terminals at different locations may receive the downlink measurement signals. A terminal device may receive reference signals in one or more beam directions, which are usually reference signals of a plurality of beams. For a type of a downlink measurement signal, refer to the downlink measurement signal mentioned in the foregoing embodiments. Details are not described herein again.

Operation 302. The terminal device detects signal strength of the downlink measurement signals by the plurality of transmit beams and feeds back a detection result to the base station.

The terminal device receives the downlink measurement signals of the plurality of beams; detects the signal strength of the downlink measurement signals of the beams, for example, measures RSRP values of the downlink measurement signals of the beams or may measure another measurement parameter such as RSRQ, which is not limited in this embodiment; and feeds back the detection result to the base station.

The detection result may be an average value or a largest value of the signal strength of the downlink measurement signals of the plurality of beams. For example, a measured largest value or an average value of RSRP of the plurality of beams may be fed back.

In another embodiment, the RSRP values of the beams may be all fed back to the base station, and the base station calculates the average value of the RSRP.

If the terminal device receives only a downlink measurement signal of one beam, only an RSRP value of the beam is fed back.

Operation 303. The base station determines that the terminal device enters a cell edge area based on the detection result, and instructs the terminal device to use an uplink signal-based measurement manner.

For example, when the base station detects that the signal strength, fed back by the terminal device, of the downlink measurement signals is lower than a specified threshold, the base station instructs the terminal device to use the uplink signal-based measurement manner.

The base station detects that an RSRP measurement value of the terminal device is lower than the specified threshold. It indicates that the terminal device enters the cell edge area. When the base station detects that RSRP measurement values of a plurality of terminal devices are lower than a specified threshold, it indicates that the plurality of terminal devices enter the cell edge area. To be specific, the base station detects that the terminal device moves to the cell edge area. In other words, when the base station determines, based on the detection result fed back by the terminal device, that the terminal device enters the cell edge area, a downlink signal-based measurement manner causes relatively high signaling overheads. The base station instructs the terminal device or the plurality of terminal devices to use an uplink signal-based measurement manner.

In addition to that the base station detects that the terminal device moves to the cell edge area, another detection condition may also be included. For example, when detecting that a quantity of terminal devices that enter the cell edge area is less than a specified threshold, the base station instructs the terminal device to use the uplink signal-based measurement manner. The threshold may be, for example, a quantity of neighboring base stations. To be specific, when detecting that the terminal device moves to the cell edge area and that the quantity of terminal devices that enter the cell edge area is less than the quantity of neighboring base stations, the base station instructs the terminal device to use the uplink signal-based measurement manner. There may be one or more terminal devices. In addition, another type of threshold may be specified.

In another implementation, after the terminal device receives the downlink measurement signals sent by the base station, the terminal device detects the downlink measurement signals. When the terminal device detects that a detection result of the downlink measurement signals is less than a specified threshold, the terminal device sends an uplink measurement signal to the base station. In other words, the terminal device actively switches to the uplink signal-based measurement manner, and the base station does not need to instruct the terminal device to switch.

In still another implementation, the terminal device receives the downlink measurement signals sent by the base station and detects the downlink measurement signals. When detecting that a detection result of the downlink measurement signals is less than a specified threshold, the terminal device reports the detection result to the network device. The base station determines, based on the detection result, that the uplink measurement signal-based measurement manner is to be used and instructs the terminal device to use the uplink measurement signal-based measurement manner. In this implementation, the base station controls whether the uplink measurement signal-based measurement manner is to be used, and reports only a detection result that is lower than the threshold, thereby reducing network overheads and avoiding frequent switching between measurement manners by the terminal device. In addition, the terminal device may further notify the base station that the uplink measurement signal-based measurement manner is to be used.

In addition to the foregoing manner of detecting signal strength of the plurality of beams in this embodiment, a manner of detecting a port may be used in another implementation. After the terminal device receives the downlink measurement signals sent by the network device, the terminal device may detect ports corresponding to the downlink measurement signals. When measurement indicators of the ports are less than a specified threshold, the terminal device sends an uplink measurement signal to the network device, or reports a detection result to the network device, and the network device determines, based on the detection result, that the uplink measurement signal-based measurement manner is to be used and notifies the terminal device.

Subsequently, the terminal device or the plurality of terminal devices may send uplink measurement signals to a corresponding base station by using one or more transmit beams. The uplink measurement signal may be an SRS or an uplink tracking signal, or another type of measurement signal. For procedures, for example, about determining, by the base station, cell handover based on the uplink measurement signal fed back by the terminal device. Details are not described herein again.

In the cell edge area, because downlink mobility measurement causes relatively high signaling overheads, uplink measurement signal-based measurement manner may further implement fast access of the terminal device, reduce a transmitting range of a downlink paging message and paging signaling overheads, and improve network performance.

In the foregoing implementations of the present disclosure, for a manner of detecting the downlink measurement signals by the terminal device, measurement may be performed for each transmit beam or for each port. A measurement indicator may use RSRP or RSRQ, or another measurement indicator. This is not limited in this embodiment of the present disclosure.

Based on the base station in Embodiment 1, a network device is further provided. Referring to FIG. 5, the network device includes:

a receiving module 501, configured to receive uplink measurement signals that are sent by a terminal device by a plurality of transmit beams;

a detection module 502, configured to determine a beam direction of an optimal transmit beam based on signal strength information of the uplink measurement signals of the plurality of beams; and

a sending module 503, configured to send a downlink measurement signal to the terminal device by using a corresponding downlink transmit beam based on the beam direction of the optimal transmit beam.

Based on the terminal device in Embodiment 2, a terminal device is provided. Referring to FIG. 5, the terminal device includes:

a receiving module 501, configured to receive downlink measurement signals that are sent by a network device by a plurality of transmit beams;

a detection module 502, configured to determine a beam direction of an optimal transmit beam based on signal strength information of the downlink measurement signals of the plurality of transmit beams; and

a sending module 503, configured to send an uplink measurement signal to the network device by using a corresponding uplink transmit beam based on the beam direction of the optimal transmit beam, where

the optimal transmit beam is a transmit beam with highest signal strength or a transmit beam whose signal strength is higher than a specified threshold.

Based on the base station in Embodiment 3, a network device is further provided. Referring to FIG. 6, the network device includes a sending module 603, a receiving module 601, and a detection module 602.

The sending module is configured to send downlink measurement signals to a terminal device by using one or more transmit beams.

The receiving module is configured to receive a detection result, fed back by the terminal device, of signal strength of the downlink measurement signals of the one or more transmit beams.

When the detection module detects that the detection result, fed back by the terminal device, of the downlink measurement signals is lower than a specified threshold, the sending module is further configured to instruct the terminal device to use an uplink measurement signal-based measurement manner.

With reference to the foregoing aspects, the receiving module is further configured to receive uplink measurement signals that are sent by the terminal device by using one or more beams.

Based on the terminal device in Embodiment 3, a terminal device is provided. Referring to FIG. 6, the terminal device includes:

a receiving module 601, configured to receive downlink measurement signals that are sent by a network device by using one or more beams; and

a detection module 602, configured to: detect signal strength of the downlink measurement signals and feed back a detection result to the network device.

When the network device detects that the detection result, fed back by the terminal device, of the downlink measurement signals is lower than a specified threshold, the receiving module is further configured to receive a notification that is sent by the network device and that indicates to use an uplink measurement signal-based measurement manner.

With reference to the foregoing aspects, the terminal device further includes a sending module 603, configured to send uplink measurement signals to the network device by using one or more beams.

In the foregoing apparatus embodiments, the network device and the terminal device respectively correspond to the base station and the terminal device in the corresponding method embodiments, and a corresponding module performs a corresponding operation. For other operations, refer to a corresponding method embodiment and a corresponding module is used for performing the other operations. Details are not described herein.

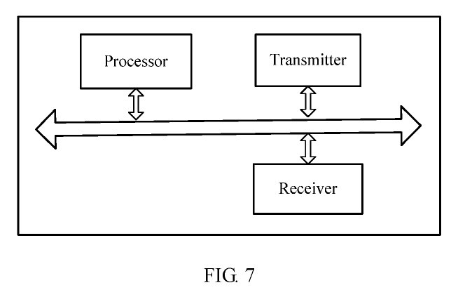

In an apparatus embodiment of another form, referring to FIG. 7, in the foregoing embodiments, the receiving module may be implemented by a receiver; the sending module may be implemented by a transmitter; and other modules such as the detection module and the detection module may be implemented by a processor. Functions corresponding to operations in another method procedure may be implemented by a processor.

In the foregoing apparatus embodiments, a corresponding function module performs a corresponding operation in the method embodiments. For detailed operations, refer to a corresponding method. Details are not described herein.

In the foregoing embodiments, the network device may be a base station, or another network device such as a transmission reception point TRP. This is not limited in the embodiments of the present disclosure.

In one embodiment, components of the device in FIG. 7 are coupled together by using a bus system, and the bus system includes a power bus, a control bus, and a status signal bus in addition to a data bus.

It should be understood that in the embodiments of the present disclosure, the processor may be a central processing unit (CPU), or another general purpose processor, a digital signal processor (DSP), an application-specific integrated circuit (ASIC), a field-programmable gate array (FPGA), or another programmable logic device, discrete gate or transistor logic device, discrete hardware component, or the like. The general purpose processor may be a microprocessor, or any conventional processor or the like.

The memory may include a read-only memory and a random access memory, and provide an instruction and data for the processor. A part of the memory may further include a non-volatile random access memory. For example, the memory may further store information about a device type.

The bus system may further include a power bus, a control bus, a status signal bus, and the like, in addition to a data bus. However, for clear description, various types of buses in the figure are marked as the bus system.

It should be understood that the term “and/or” in this specification describes only an association relationship for describing associated objects and represents that three relationships may exist. For example, A and/or B may represent the following three cases: Only A exists, both A and B exist, and only B exists. In addition, the character “/” in this specification usually indicates an “or” relationship between the associated objects.

It should be understood that sequence numbers of the foregoing processes do not mean execution sequences in the embodiments of the present disclosure. The execution sequences of the processes should be determined according to functions and internal logic of the processes, and should not be construed as any limitation on the implementation processes of the embodiments of the present disclosure.

A person of ordinary skill in the art may be aware that, in combination with the examples described in the embodiments disclosed in this specification, units and algorithm operations may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, function units in the embodiments of the present disclosure may be integrated into one processing unit, or each of the units may exist alone physically, or two or more units are integrated into one unit.

When the functions are implemented in a form of a software function unit and sold or used as an independent product, the functions may be stored in a computer-readable storage medium. Based on such an understanding, the technical solutions of the present disclosure essentially, or the part contributing to the prior art, or some of the technical solutions may be implemented in a form of a software product. The computer software product is stored in a storage medium, and includes instructions for instructing a computer device (which may be a personal computer, a server, or a network device) to perform all or some of the operations of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A method for sending a measurement signal, comprising:
sending, by a network device, downlink measurement signals to a terminal device by using one or more transmit beams;
receiving, by the network device, a detection result, fed back by the terminal device, of signal strength of the downlink measurement signals; and
when detecting that the detection result is lower than a specified threshold, instructing, by the network device, the terminal device to use an uplink measurement signal-based measurement manner.

2. The method according to claim 1, wherein the detection result of the signal strength of the downlink measurement signals is an average value or a largest value of signal strength of downlink measurement signals of a plurality of transmit beams.

3. The method according to claim 1, further comprising: receiving uplink measurement signals that are sent by the terminal device by using one or more beams.

4. The method according to claim 1, wherein the uplink measurement signal is an uplink reference signal or an uplink tracking signal.

5. The method according to claim 1, wherein the downlink measurement signals are downlink reference signals, channel state information-reference signals or measurement reference signals.

6. A method for receiving a measurement signal, comprising:
receiving, by a terminal device, downlink measurement signals that are sent by a network device by using one or more beams;
detecting, by the terminal device, signal strength of the downlink measurement signals and feeding back a detection result to the network device; and
when the network device detects that the detection result, fed back by the terminal device, of the downlink measurement signals is lower than a specified threshold, receiving, by the terminal device, a notification that is sent by the network device and that indicates to use an uplink measurement signal-based measurement manner.

7. The method according to claim 6, wherein the detection result of the signal strength of the downlink measurement signals is an average value or a largest value of signal strength of downlink measurement signals of a plurality of transmit beams.

8. The method according to claim 6, further comprising: sending, by the terminal device, uplink measurement signals to the network device by using one or more beams.

9. The method according to claim 6, wherein the detecting, by the terminal device, signal strength of the downlink measurement signals, and feeding back a detection result to the network device specifically comprises:
measuring, by the terminal device, ports corresponding to the downlink measurement signals to obtain measurement indicators of the ports, and sending the measurement indicators of the ports to the network device; or
measuring, by the terminal device, the beams corresponding to the downlink measurement signals to obtain measurement indicators of the beams, and sending the measurement indicators of the beams to the network device.

10. The method according to claim 6, wherein the uplink measurement signal is an uplink reference signal or an uplink tracking signal.

11. The method according to claim 6, wherein the downlink measurement signals are downlink reference signals, channel state information-reference signals or measurement reference signals.

12. A network device, comprising: a transceiver and a processor, the processor implementing instructions causing the network device to
send downlink measurement signals to a terminal device by using one or more transmit beams;
receive a detection result, fed back by the terminal device, of signal strength of the downlink measurement signals; and
when detect that the detection result is lower than a specified threshold, instruct the terminal device to use an uplink measurement signal-based measurement manner.

13. The network device according to claim 12, wherein the detection result of the signal strength of the downlink measurement signals is an average value or a largest value of signal strength of downlink measurement signals of a plurality of transmit beams.

14. The network device according to claim 12, receive uplink measurement signals that are sent by the terminal device by using one or more beams.

15. The network device according to claim 12, wherein the uplink measurement signal is an uplink reference signal or an uplink tracking signal.

16. The network device according to claim 12, wherein the downlink measurement signals are downlink reference signals, channel state information-reference signals or measurement reference signals.

17. A terminal device, comprising a transceiver and a processor, the processor implementing instructions causing the terminal device to
receive downlink measurement signals that are sent by a network device by using one or more beams;
detect signal strength of the downlink measurement signals and feeding back a detection result to the network device; and
receive, by the terminal device, a notification that is sent by the network device and that indicates to use an uplink measurement signal-based measurement manner.

18. The terminal device according to claim 17, wherein the detection result of the signal strength of the downlink measurement signals is an average value or a largest value of signal strength of downlink measurement signals of a plurality of transmit beams.

19. The terminal device according to claim 17, wherein the instructions further cause the terminal device to send uplink measurement signals to the network device by using one or more beams.

20. The terminal device according to claim 17, wherein the detect signal strength of the downlink measurement signals, and feed back a detection result to the network device specifically comprises:
measure ports corresponding to the downlink measurement signals to obtain measurement indicators of the ports, and sending the measurement indicators of the ports to the network device; or
measure the beams corresponding to the downlink measurement signals to obtain measurement indicators of the beams, and sending the measurement indicators of the beams to the network device.
